(19) United States
(12) Patent Application Publication
(10) Pub. No.: US 2015/0114676 A1
(43) Pub. Date: Apr. 30, 2015

(54) CONDUCTOR BAR WITH MULTI-STRAND CONDUCTOR ELEMENT

(71) Applicant: ALSTOM Technology Ltd., Baden (CH)

(72) Inventors: Grégoire VIENNE, Fribourg (CH); Hossein Safari-Zadeh, Othmarsingen (CH); Johann Haldemann, Birr (CH)

(73) Assignee: ALSTOM Technology Ltd., Baden (CH)

(21) Appl. No.: 14/068,442

(22) Filed: Oct. 31, 2013

(51) Int. Cl. H01B 7/30; H01B 13/06; H01B 13/02

(52) U.S. Cl. CPC H01B 7/306; H01B 13/02; H01B 13/06
USPC 174/34; 29/868

(57) ABSTRACT

A conductor bar including a plurality of Roebel-transposed conductor elements is disclosed. At least one of the conductor elements possesses a plurality of conductive strands stacked relative to each other. The strands used to form the at least one conductor element follow a common path within the conductor bar. An insulator electrically insulates the conductor elements from each other. Also provided are a method of manufacturing a conductor bar and an electric machine including a plurality of conductor bars.

### TECHNICAL FIELD

The present disclosure relates to a conductor bar including a plurality of Roebel-transposed conductor elements, a method of manufacturing a conductor bar, and an electric machine incorporating a plurality of conductor bars.

### BACKGROUND

A known conductor bar including a plurality of Roebel-transposed conductor elements is illustrated in FIG. 1 of U.S. Pat. No. 6,725,071. Each conductor element includes a plurality of bent portions so that the conductor element is transposed multiple times throughout the conductor bar. The shifting position of the conductor element suppresses energy losses caused by eddy and circulating currents.

The energy losses in a conductor bar increase as the frequency of the electricity passing through the conductor bar increases. The conductor elements of a known conductor bar, such as the one depicted in FIG. 1. of U.S. Pat. No. 6,725,071, are each formed of a single conductive strand. This aspect of the conductor bar can impact energy losses at high frequencies.

A need exists for a conductor bar operable at relatively high frequencies, e.g., greater than 60 Hz, without substantial energy losses.

### SUMMARY

Disclosed herein is a conductor bar including a plurality of Roebel-transposed conductor elements and an insulator which electrically insulates the conductor elements from each other. At least one of the conductor elements possesses a plurality of conductive strands stacked relative to each other. The strands used to formed the at least one conductor element follow a common path within the conductor bar.

Also disclosed is a method of manufacturing a conductor bar including a plurality of longitudinally-extending conductive strands. The method includes removing first and second portions along opposite sides of a longitudinal centerline of each strand so that a remaining portion of the strand includes a Z-shape or an L-shape. The method includes coating each strand with a layer of electrically insulating material, and stacking at least two strands relative to each other to form a conductor element. The method additionally includes weaving together a plurality of the conductor elements in a Roebel-transposed configuration in a manner such that the strands used to form each conductor element follow a common path within the conductor bar.

Also described is an electric machine including a plurality of conductor bars possessing a rectangular cross section and which are formed in a loop. Each conductor bar includes a plurality of Roebel-transposed conductor elements. At least one of the conductor elements possesses a plurality of conductive strands stacked relative to each other. The conductive strands of the conductor element follow a common path within the conductor bar. Each conductor bar includes an insulator for electrically insulating the conductor elements from each other.

### BRIEF DESCRIPTION OF THE DRAWINGS

Objects and advantages of the invention will become apparent upon reading the following detailed description and upon reference to the drawings, in which:

FIG. 1 illustrates several cross-sectional views along the length of an exemplary conductor bar 110;

FIG. 1(a) shows a cross-sectional view of the conductor element A of FIG. 1;

FIG. 2 illustrates a top view of an exemplary conductor bar 210;

FIG. 3 depicts several cross-sectional views along the length of an exemplary conductor bar 310;

FIG. 3(a) illustrates a cross-sectional view of a portion of the conductor element A before a layer swap in the conductor bar 310 depicted in FIG. 3;

FIG. 3(b) illustrates a cross-sectional view of a portion of the conductor element A near the middle of the conductor bar 310 depicted in FIG. 3;

FIG. 4(a) illustrates exemplary conductive strands 330, 340 before they are assembled together to form the conductor element 320;

FIG. 4(b) depicts the conductive strands 330, 340 after assembly;

FIG. 4(c) is an enlarged view of the transposition of the conductive strands 330, 340 shown in FIG. 4(b);

FIG. 5(a) illustrates an enlarged view of the transposition of the conductive strands 510, 520, 530 and 540;

FIG. 5(b) illustrates the two slits formed in the conductive strand 510 shown in FIG. 5(a);

FIG. 5(c) depicts the conductive strands 510, 520, 530 and 540 prior to assembly;

FIG. 6 shows several cross-sectional views along the length of an exemplary conductor bar 610;

FIG. 6(a) illustrates a cross-sectional view of a portion of the conductor element A near the end of the conductor bar 610 shown in FIG. 6;

FIG. 6(b) illustrates a cross-sectional view of a portion of the conductor element A near the middle of the conductor bar 610 shown in FIG. 6;

FIG. 7 illustrates wrapping the conductive strands 630, 650 around the conductive strand 640 to form the conductive element 620;

FIGS. 8-10 depict top views of exemplary conductor bars 810, 910 and 1010, respectively;

FIG. 11 illustrates several cross-sectional views along the length of an exemplary conductor bar 1110;

FIG. 11(a) shows a cross-sectional view of a portion of the conductor element A near the first end of the conductor bar 1110 shown in FIG. 11;

FIG. 11(b) depicts a cross-sectional view of a portion of the conductor element A near the middle of the conductor bar 1110 shown in FIG. 11;

FIG. 11(c) illustrates a cross-sectional view of a portion of the conductor element A near the middle of the conductor bar 1110 shown in FIG. 11;

FIG. 11(d) depicts a cross-sectional view of a portion of the conductor element A near the second end of the conductor bar 1110 shown in FIG. 11;

FIG. 12(a) illustrates an exemplary conductive strand 1200 prior removal of the side portions;

FIG. 12(b) shows the conductive strand 1200 after removal of the side portions;

FIG. 12(c) shows the conductive strand 1200 of FIG. 12(b) viewed along line A-A; and

FIGS. 13 and 13(a) show an electric generator including a plurality of conductor bars.

### DETAILED DESCRIPTION

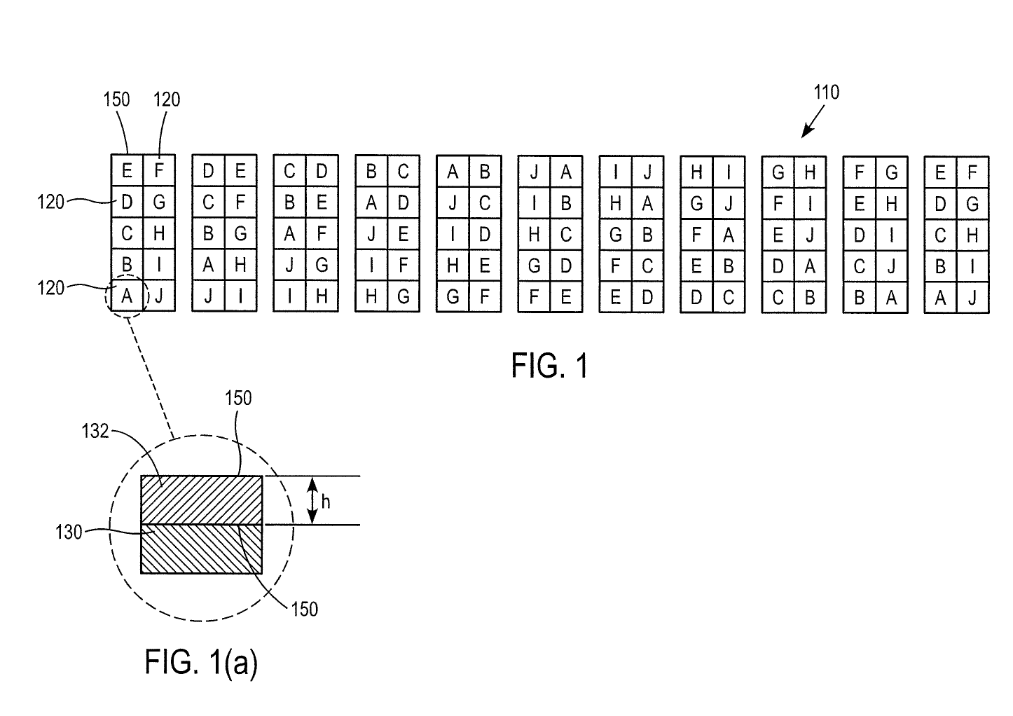

FIG. 1 illustrates several cross-sectional views of a conductor bar 110 according to an exemplary embodiment disclosed herein. Each cross-sectional view is taken at a different point along the length of the conductor bar 110. The conductor bar 110 is formed of a plurality of Roebel-transposed conductor elements 120. The conductor bar 110 includes ten conductor elements 120 labeled A, B, C, D, E, F, G, H, I and J. The conductor elements 120 change relative positions throughout the conductor bar 110 by virtue of their Roebel transposition.

FIG. 1 depicts a Roebel transposition where the configuration of the conductor elements 120 incrementally rotates in each cross section of the conductor bar 110. The cross sections depicted in FIG. 1 are spaced apart equally along the length of the conductor bar 110, but can also be spaced apart at different distances along the length conductor bar 110.

FIG. 1 shows that at one end of the conductor bar, conductor element A is positioned at the lower, left-hand side of the conductor bar 110. Moving longitudinally along the length of the conductor bar 110, the conductor element A moves towards the top of the conductor bar 110. When the conductor element A reaches the top of the conductor bar 110, the conductor element A switches from the left-hand side of the conductor bar 110 to the right-hand side of the bar. This switch between left and right sides of the conductor bar 110 is called a transposition.

At least some of the conductor elements 120 are formed of a plurality of conductive strands 130 stacked relative to each other. The conductive strands 130 are made of an electrically conductive material such as copper or any other conductive material. FIG. 1(a) shows a cross-sectional view of the conductor element A of FIG. 1. The conductor element A is formed of two conductive strands 130, 132. Each of the conductive strands 130, 132 follows the same path as the conductor element 120. Thus, each of the conductive strands 130 follows a common path within the conductor bar 110.

Each of the conductive strands 130, 132 possesses a rectangular cross section and is relatively thin. The conductor strands 130, 132 possess a height h of approximately (e.g., ±10%) 0.3-0.8 mm, or lesser or greater. For example, the height h of each conductive strand is between 0.4-0.6 mm. Energy losses (i.e., stator losses) in the conductor bar 110 are reduced by constructing at least one of the conductor elements 120 with multiple, relatively thin conductive strands. The conductor bar 110 is therefore operable at relatively high frequencies, for example frequencies greater than 60 Hz, without substantial stator losses. This is because the electric current in each individual strand 130, 132 is more uniformly distributed.

The conductor bar 110 illustrated in FIG. 1 possesses a 360° transposition. Each conductor element 120 is therefore positioned, at least one time, along the top of the conductor bar 110 and along the bottom of the conductor bar 110. The conductor bar according to the present invention is not limited to a 360° transposition, and may possess any transposition angle.

The conductor bar 110 illustrated in FIG. 1 is formed of two columns of conductor elements 120, with each column including five conductor elements 120. The conductor bar 110 can possess any number of columns, including a single column. The number of conductor elements 120 in each column is not limited to the number of conductor elements 120 shown in the FIG. 1. In an exemplary embodiment, each column of the conductor bar 110 is formed of at least 70 conductor elements.

An insulator 150 electrically insulates the conductor elements 120 from each other. The insulator 150 can be formed in one-piece or multiple, separate elements. Each of the conductive strands 130, 132 is also electrically insulated from each other. An exemplary embodiment involves employing the insulator 150 to electrically insulate the conductive strands 130, 132 from each other. A B-stage coating (not shown in FIG. 1) may be applied to the layer of electrically insulating material 160. The B-stage coating can be a semi-conductive epoxy including, for example, SiC, or other suitable material. The B-stage coating operates, in an embodiment, as an adhesive which holds together the conductive strands 130 during assembly.

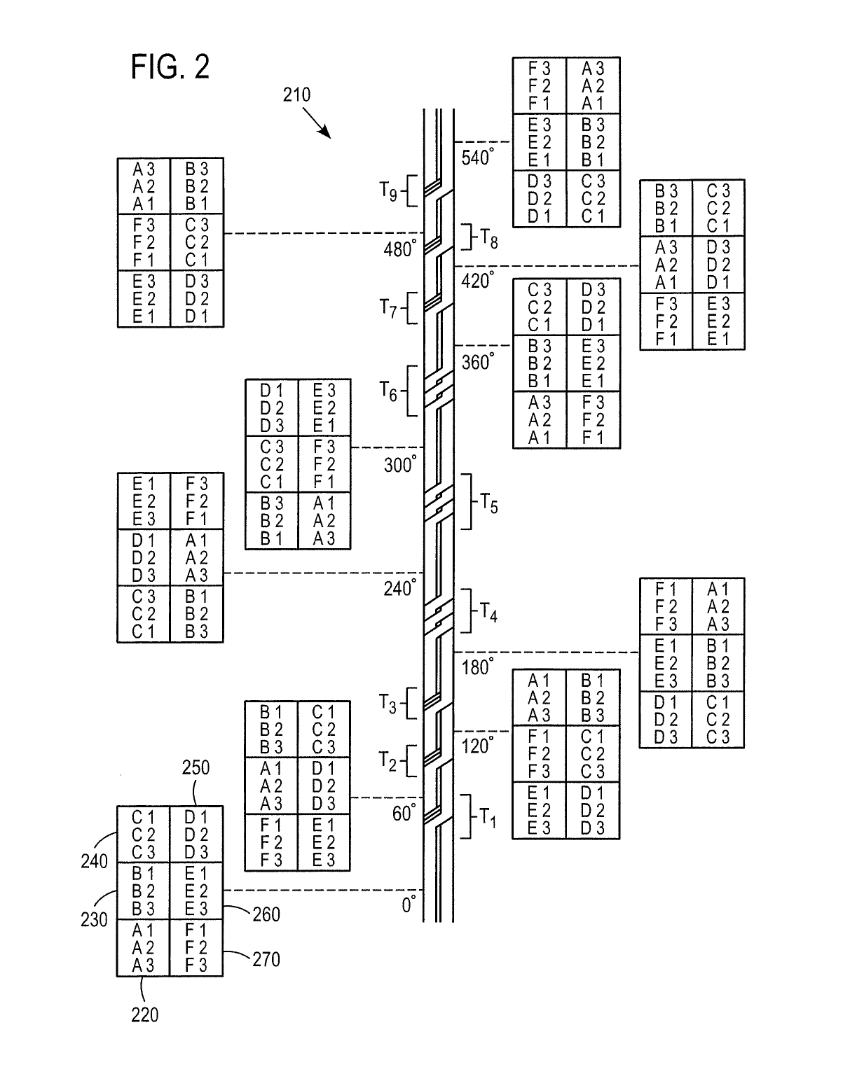

FIG. 2 illustrates a top view of a conductor bar 210 formed of a plurality of Roebel-transposed conductor elements 220, 230, 240, 250, 260 and 270. The conductor elements 220, 230, 240, 250, 260 and 270 are Roebel-transposed in a manner resulting in a 540° transposition angle. FIG. 2 also depicts cross sections of the conductor bar 210 at various points along the length of the conductor bar 210. The cross sections show that each conductor element includes three conductive strands. For example, conductor element 220 includes conductive strands A1, A2, and A3. The transpositions of the conductor elements positioned along the top of the conductor bar 210 are labeled with reference numerals T1-T9 in FIG. 2. Transpositions of the conductor elements also occur along the bottom of the conductor bar 210.

At the transposition T1, the conductor element 240 switches from the left side of the conductor bar 210 to the right side of the conductor bar. The transposition T2 involves conductor element 230 switching from the left side of the conductor bar 210 to the right side of the conductor bar. At the transposition T3, the conductor element 220 switches from the left side of the conductor bar 210 to the right side of the conductor bar. The transposition T7 involves the conductor element 240 switching from the left side of the conductor bar 210 to the right side of the conductor bar. The transposition T8 involves conductor element 230 switching from the left side of the conductor bar 210 to the right side of the conductor bar. At the transposition T9, the conductor element 220 switches from the left side of the conductor bar 210 to the right side of the conductor bar.

At each of the transpositions T4, T5 and T6, a respective conductor element switches sides of the conductor bar 210, and additionally, the uppermost and bottommost conductive strands of the respective conductor element switch layers. For example, transposition T4 involves conductor element 270 switching from the left side of the conductor bar 210 to the right side of the conductor bar 210. Additionally, the conductive strands F1 and F3 switch layers with each other at the transposition T4.

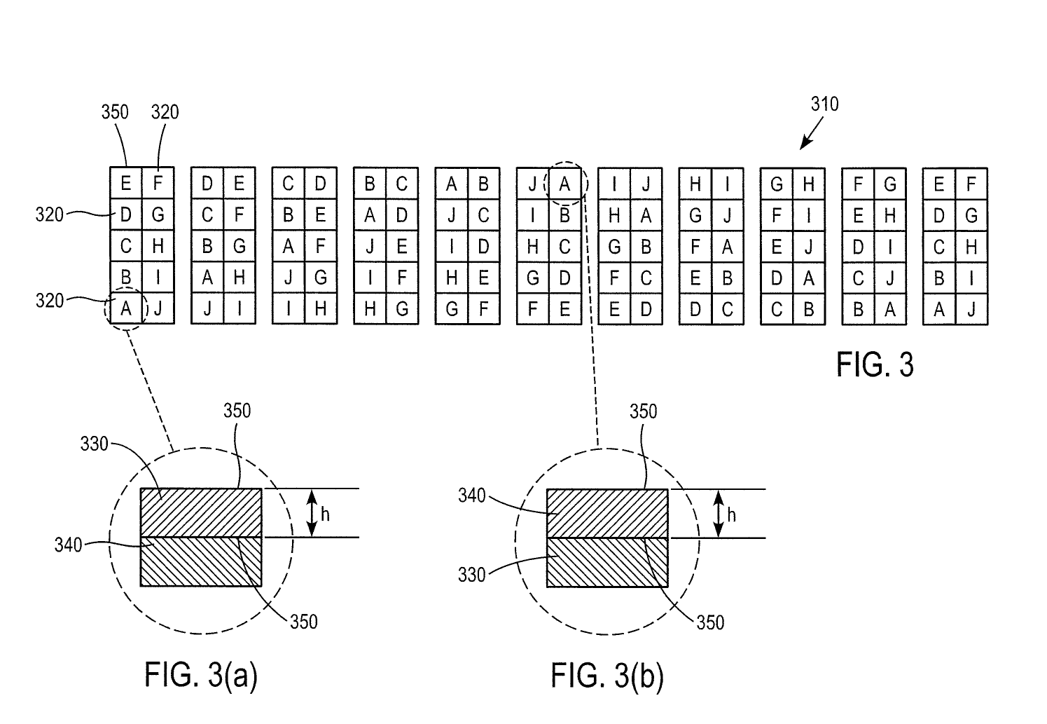

FIG. 3 illustrates another embodiment of the disclosure herein. FIG. 3 depicts a conductor bar 310 including a plurality of Roebel-transposed conductor elements 320. An insulator 350 electrically insulates the conductor elements 320 from each other. At least some of the conductor elements 320, such as conductor element A, are formed of a plurality of conductive strands 330, 340 stacked relative to each other. The conductive strands 330, 340 follow a common path within the conductor bar 310. The conductive strands each possess a rectangular cross-section. The height h of each of the conductive strands is approximately (e.g., ±10%) 0.3-0.8 mm, and for example between 0.4-0.6 mm. An insulator 350 electrically insulates the conductor elements 320 from each other, and electrically insulates each of the conductive strands 330, 340 from each other. A B-stage coating including, for example, SiC covers the insulator 350.

The conductive strands 330, 340 switch layers with each other so that the conductive strands 330, 340 are transposed. FIG. 3(a) illustrates the conductive strands 330, 340 before the layer swap, and FIG. 3(b) illustrates the conductive strands 330, 340 after the layer swap. The layer swap of the conductive strands 330, 340 occurs in the portion of the conductor element A positioned at the top and/or the bottom of the conductor bar 310. The layer swap may also occur at any other point along the height the height of the conductor bar 310.

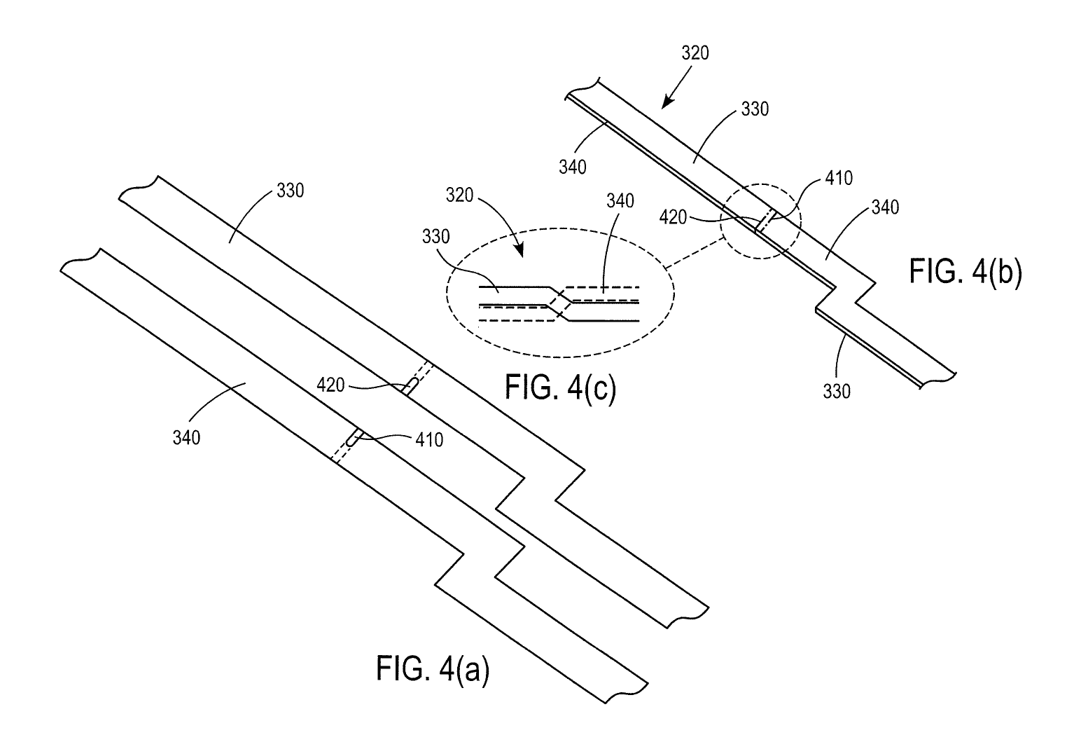

The layer swap of the conductive strands 330, 340 is accomplished by wrapping or twisting the conductive strands 330, 340 around each other. In one embodiment, the conductive strands 330, 340 switch layers by passing through slits formed in each of the conductive strands 330, 340. The conductive strands 330, 340 illustrated in FIG. 4(a) include such slits. The conductive strand 330 possesses a slit 410, and the conductive strand 340 has a slit 420. FIG. 4(b) depicts the conductive stands 330, 340 after they are weaved together to form the conductor element 320. FIG. 4(b) shows that the conductive strand 340 passes through the slit 420 formed in the conductive strand 330, and that the conductive strand 330 passes through the slit 410 formed in the conductive strand 340. An enlarged view of the layer sap of the conductive strands 330, 340 is shown in FIG. 4(c).

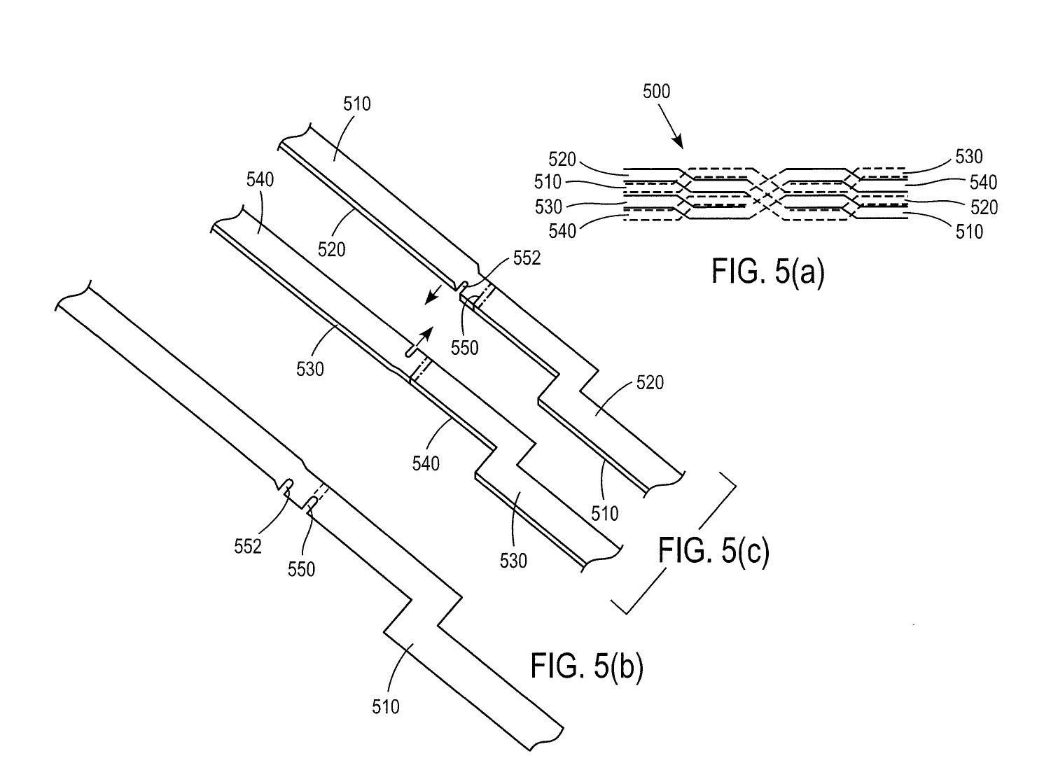

FIG. 5(a) illustrates a conductor element 500 formed of conductive strands 510, 520, 530 and 540. Each of the conductive strands 510, 520, 530 and 540 possesses two slits. The conductive strand 510 includes slits 550, 552 as shown in FIG. 5(b). FIG. 5(c) shows that the conductive strand 510 passes through a slit in the conductive strand 520, and that the conductive strand 520 passes through the slit 550 in the conductive strand 510. This results in the layer swap of the conductive strands 510, 520. FIG. 5(c) also shows that the conductive strand 540 passes through a slit formed in the conductive strand 540, and that the conductive strand 540 passes through a slit formed in the conductive strand 530 so that the conductive strands 530, 540 are transposed. The combination of the conductive strands 510, 520 is transposed with the combination of the conductive strands 530, 540 by way of the second slit formed in each of the conductive strands. The resulting conductor element 500 is shown in FIG. 5(a).

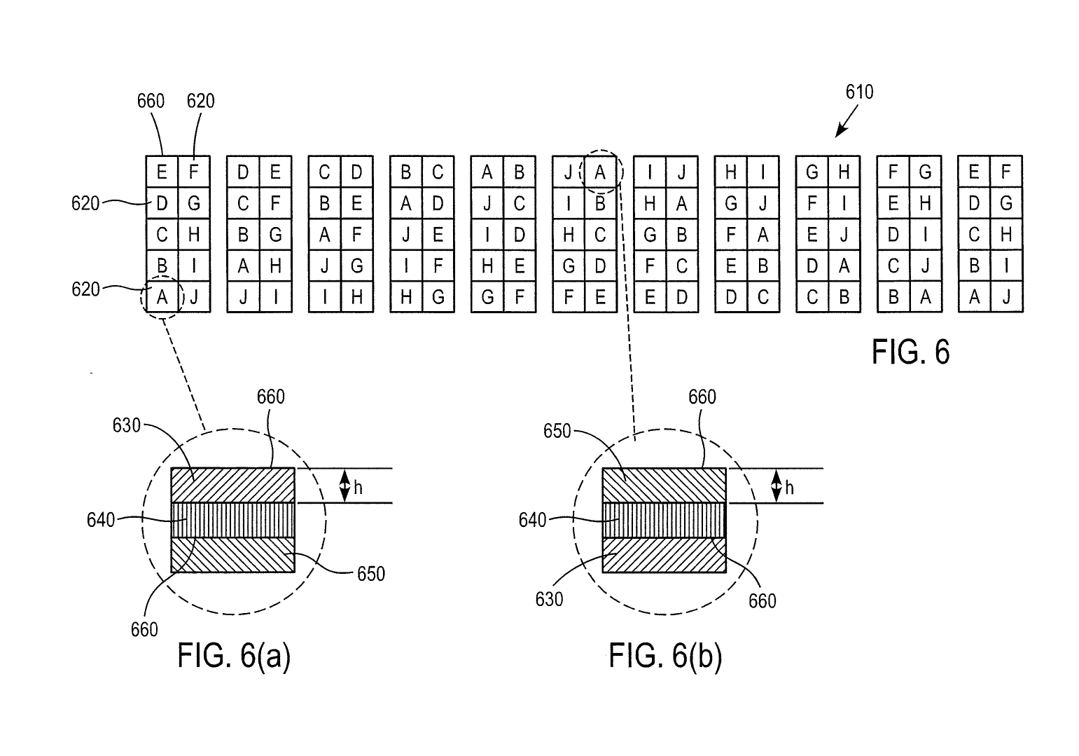

FIG. 6 depicts a conductor bar 610 including Roebel-transposed conductor elements 620. One of the conductor elements 620 (e.g., conductor element A) is formed of three conductive strands 630, 640 and 650. The conductive strands 630, 640 and 650 follow a common path within the conductor bar 610. The conductive strands 630, 640 and 650 possess a rectangular cross-section, and a height h of approximately 0.3-0.8 mm. For example, the height h is between 0.4-0.6 mm. An insulator 660 electrically insulates the conductor elements 620 from each other, and electrically insulates the conductive strands 630, 640 and 650 from each other. A B-stage coating including, for example, SiC may coat the insulator 660.

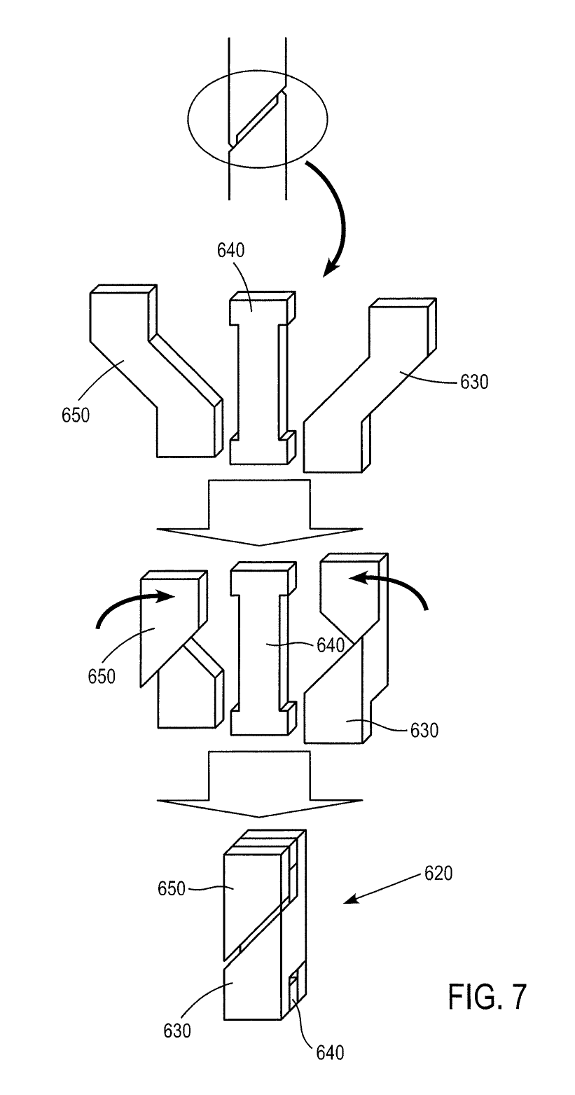

The conductive strands 630, 650 switch layers with each other. The conductive strand 640 maintains its position between the conductive strands 630, 650. FIGS. 6(a) and 6(b) illustrate cross sections of the conductor element A before and after the layer swap of the conductive strands 630 and 650. The manner in which the conductive strands 630, 650 are wrapped around the conductive strand 640 is shown FIG. 7. FIG. 7 shows that one portion of the conductive strand 630 is positioned on one side of the conductive strand 640, while another portion of the conductive strand 630 is positioned on the opposite side of the conductive strand 640. The conductive strand 650 also includes respective portions positioned on opposite sides of the conductive strand 640. The conductive strand 640 may be I-shaped as depicted in FIG. 7 so that the conductive strands 630, 650 wrap around the middle portion of the strand 640. The width of the middle portion of the conductive strand 640 is reduced to allow the other two conductive strands 630, 650 to switch positions without exceeding the initial width of the conductor element 620. The twisting of the conductor element 620 shown in FIG. 7 results in better loss distribution, and thus reduces the likelihood of localized hot spots.

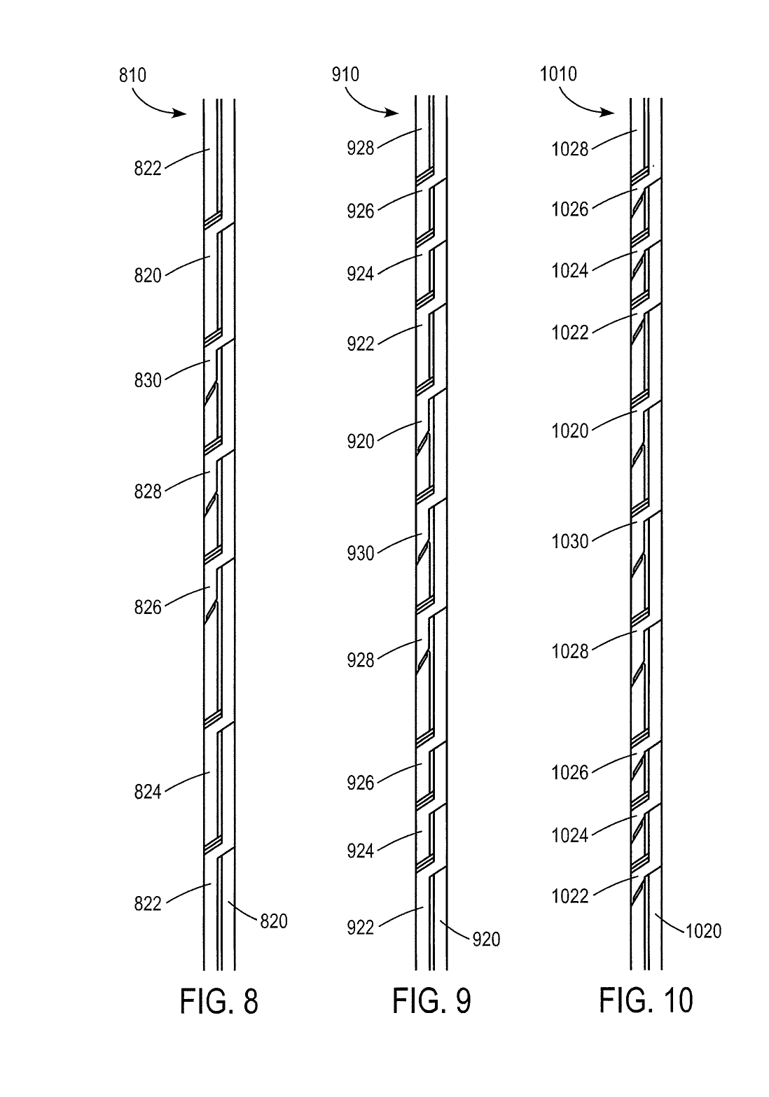

FIG. 8 illustrates a top view of a conductor bar 810 formed of a plurality of Roebel-transposed conductor elements 820-830. The conductor elements 820-830 are stacked in two columns, with each column including three conductor elements. The conductor elements 820-830 are Roebel-transposed in a manner resulting in an exemplary 540° transposition angle. Each conductor element is formed of three conductive strands. The conductive strands within each individual conductor element are twisted around each other in the manner shown in FIG. 7. That is, the upper and lower strands are wrapped around the middle strand. FIG. 8 shows that the twisting occurs in the portion of each of the conductor elements 826, 828 and 830 positioned along the top of the conductor bar 810. The conductor elements 820, 822 and 824 each include a portion positioned along the bottom of the conductor bar 810 which is twisted. The twisted portions do not necessarily have to be positioned along the top or the bottom of the conductor bar 810, and may be positioned anywhere along the height of the conductor bar 810. Each conductor element of the conductor bar 810 illustrated in FIG. 8 includes one twisted portion so that the conductive strand transposition of each conductor element is 180°.

The twisted portions of the conductor elements illustrated in FIG. 8 are centrally located along the length of the conductor bar 810. This configuration of the twisted portions is electromagnetically advantageous because the induced part on the right side of the twist is exposed to a similar magnetic field as the induced part on the left side of the twist.

FIG. 9 depicts a top view of a conductor bar 910 formed of a plurality of Roebel-transposed conductor elements 920-930. The conductor bar 910 is similar to the conductor bar 810 illustrated in FIG. 8, except that the conductor elements of the conductor bar 910 are Roebel-transposed in a manner resulting in a 540° transposition angle. Each conductor element of the conductor bar 910 includes one twisted portion so that the conductive strand transposition of each conductor element is, for example, 180°.

FIG. 10 depicts a top view of a conductor bar 1010 formed of a plurality of Roebel-transposed conductor elements 1020-1030. The conductor elements 1020-1030 are stacked in two columns, with each column including three conductor elements. The conductor elements 1020-1030 are Roebel-transposed in a manner resulting in a 540° transposition angle. Each conductor element is formed of three conductive strands. The conductive strands within each individual conductor element are twisted around each other in the manner shown in FIG. 7. Each conductor element of the conductor bar 1010 includes three twisted portions so that the conductive strand transposition of each conductor element is 540°. The materials and coatings discussed above with regard to the conductor bar 110 can be implemented in the conductor bars 810, 910 and 1010.

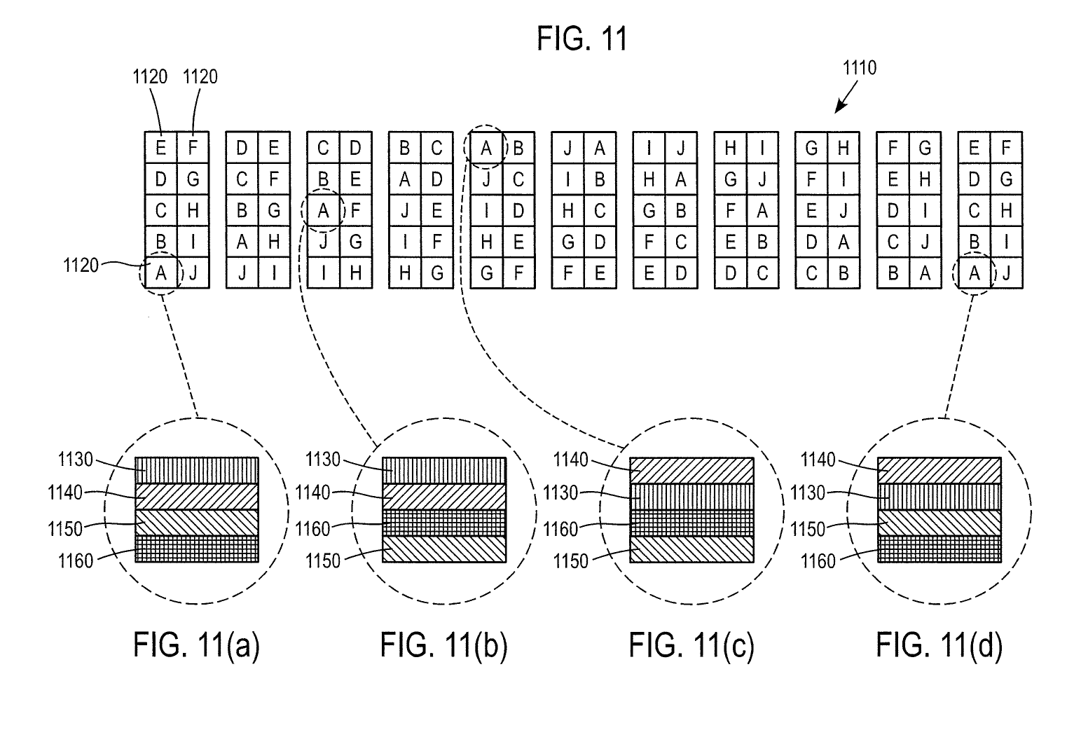

Another embodiment of the conductor bar is illustrated in FIG. 11. The conductor bar 1110 includes at least one conductor element 1120 possessing four conductive strands 1130, 1140, 1150 and 1160. FIGS. 11(a)-11(d) show that the conductive strands 1130, 1140 swap layers with each other, and that the conductive strands 1150, 1160 swap layers with each other. The conductive strands 1130, 1140 can be wrapped around each other, or wound through slits in the manner shown in FIGS. 4(a)-4(c). The layer swap of the conductive strands 1150, 1160 is accomplished by wrapping the conductive strands 1150, 1160 around each other, or weaving the conductive strands 1150, 160 through slits described in FIGS. 4(a)-4(c).

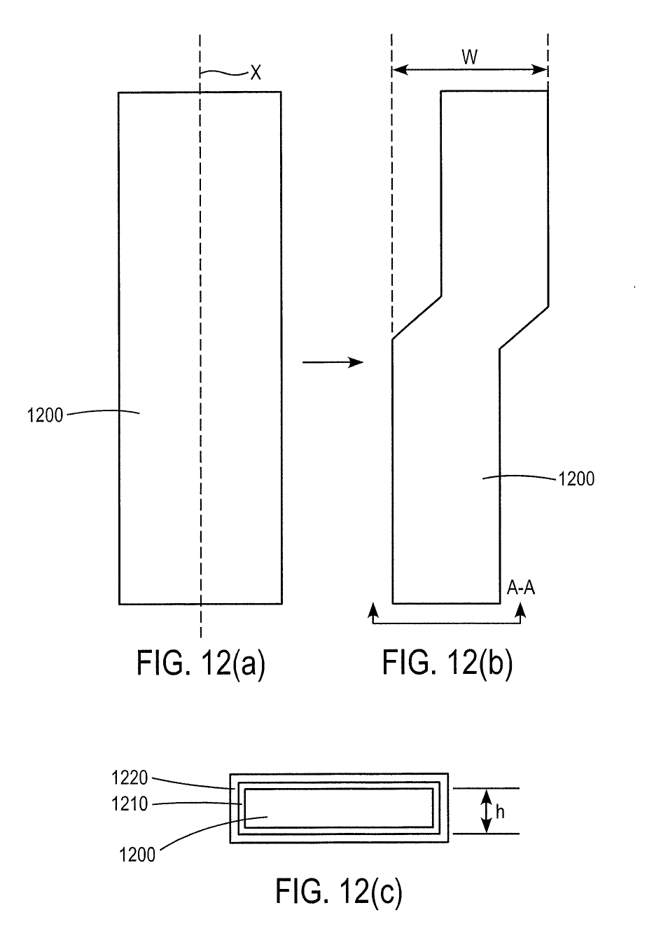

The following is a description of an exemplary method of manufacturing a conductor bar including a plurality of longitudinally-extending conductive strands 1200. Each conductive strand 1200 includes a longitudinal centerline X as shown in FIG. 12(a). The method includes removing first and second portions along opposites of the longitudinal centerline X of each of the strands 1200 so that a remaining portion of each strand 1200 includes a Z-shape or an L-shape as shown in FIG. 12(b). The first and second portions can be removed, for example, by a punching operation. Each strand is then coated with a layer of electrically insulating material 1210. The electrically insulating material 1210 can be sprayed, screened and/or brushed in liquid form on the conductive strand 1200 and then dried. Next, at least two of the strands 1200 are stacked relative to each other to form a conductor element. Subsequently, a plurality of conductor elements are weaved together in a Roebel-transposed configuration. The strands of each conductor element follow a common path within the conductor bar.

Each strand 1200 possesses a rectangular cross section and a height h of about (e.g., ±10%) 0.3-0.8 mm as shown in FIG. 12(c). The height h is for example between 0.4-0.6 mm. The width w of each strand is, for example, approximately 20-25 mm.

Prior to stacking the conductive strands 1200 relative to each other to form the conductor element, the strands 1200 may be coated with a B-stage material 1220 so that the B-stage material 1220 covers the electrically insulating material 1210. In an exemplary embodiment, the B-stage material 1220 is a semi-conductive material containing SiC. The B-stage material 1220 adheres the conductive strands 1200 together at least during assembly of the conductor bar 1200. This reduces the likelihood of the conductive strands 1200 becoming displaced, for example, when the conductor elements are weaved together.

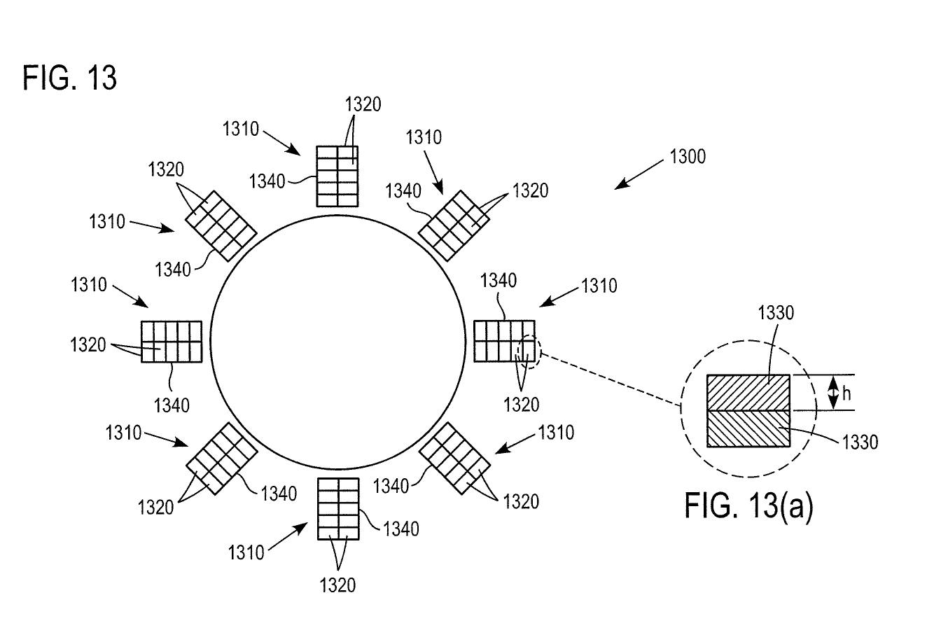

The conductor bars are implemented in various electric machines such as an electric generator or a transformer. FIG. 13 is an illustration of an electric generator 1300 incorporating a plurality of conductor bars 1310. Each conductor bar 1310 possesses a rectangular cross section and is formed in a loop. Each conductor bar 1310 includes a plurality of Roebel-transposed conductor elements 1320. At least one of the conductor elements 1320 possesses a plurality of conductive strands 1330 stacked relative to each other as shown in FIG. 13(a). The conductive strands 1330 follow a common path within the conductor bar 1310. Each conductor bar 1310 also includes an insulator 1340 for electrically insulating the conductor elements 1320 from each other. Each of the conductive strands 1330 may possess a rectangular cross section and a height of approximately 0.3-0.8 mm as shown in FIG. 13 (a).

The conductive strands 1330 forming the conductor element 1320 may be transposed with each other so that the conductive strands 1330 switch layers. There are several different ways to transpose the conductive strands 1330. The conductive strands 1330 may be wrapped around each other so that the conductive strands 1330 switch layers with each other. One of the conductive strands 1330 may pass through a slit formed in another one of the conductive strands 1330, and vice versa, so that the conductive strands 1330 are transposed. The conductive strands 1330 may also be transposed as shown in FIG. 5(a) and/or FIG. 7.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A conductor bar comprising:
a plurality of Roebel-transposed conductor elements, at least one of the conductor elements possessing a plurality of conductive strands stacked relative to each other, wherein the strands used to form the at least one conductor element follow a common path within the conductor bar; and
an insulator for electrically insulating the conductor elements from each other.

2. The conductor bar of claim 1, wherein each of the strands possesses a rectangular cross section and a height of 0.3-0.8 mm.

3. The conductor bar of claim 1, wherein each strand is coated with a layer of electrically insulating material.

4. The conductor of claim 1, wherein the at least one conductor element comprises:
a first strand and a second strand wrapped around each other so that the first and second strands are transposed.

5. The conductor of claim 4, wherein each of the first and second strands possesses a rectangular cross section and a height of 0.3-0.8 mm.

6. The conductor of claim 1, wherein the at least one conductor element comprises:
a first strand, a second strand and a third strand, the first strand being wrapped at least once around the third strand so that different portions of the first strand are located on opposite sides of the third strand, and the second strand being wrapped at least once around the third strand so that different portions of the second strand are located on opposite sides of the third strand.

7. The conductor of claim 1, wherein the at least one conductor element comprises:
a first strand and a second strand, the first strand passing through a slit in the second strand, and the second strand passing through a slit in the first strand so that the first and second strands are transposed.

8. The conductor of claim 7, the first strand passing through multiple slits in the second strand, and the second strand passing through multiple slits in the first strand so that the first and second strands are transposed multiple times.

9. The conductor of claim 7, wherein each of the first and second strands possesses a rectangular cross section and a height of 0.3-0.8 mm.

10. A method of manufacturing a conductor bar including a plurality of longitudinally-extending conductive strands, the method comprising:
removing first and second portions along opposite sides of a longitudinal centerline of each strand so that a remaining portion of the strand includes a Z-shape or an L-shape;
coating each strand with a layer of electrically insulating material;
stacking at least two strands relative to each other to form a conductor element; and
weaving together a plurality of the conductor elements in a Roebel-transposed configuration, wherein the strands used to form each conductor element follow a common path within the conductor bar.

11. The method of claim 10, wherein each of the strands possesses a rectangular cross section and a height of 0.3-0.8 mm.

12. The method of claim 10, wherein at least one of the conductor elements is formed by wrapping a first strand and a second strand around each other so that the first and second strands are transposed.

13. The method of claim 12, wherein each of the first and second strands possesses a rectangular cross section and a height of 0.3-0.8 mm.

14. The method of claim 10, wherein at least one of the conductor elements is formed by wrapping a first strand around a third strand so that different portions of the first strand are positioned on opposite sides of the third strand, and wrapping a second strand around the third strand so that different portions of the second strand are located on opposite sides of the third strand.

15. The method of claim 10, wherein at least one of the conductor elements is formed by weaving a first strand through a slit in a second strand and weaving the second strand through a slit in the first strand so that the first and second strands are transposed.

16. The method of claim 15, comprising:
weaving the first strand through multiple slits in the second strand and weaving the second strand through multiple slits in the first strand so that the first and second strands are transposed multiple times.

17. An electric machine comprising:
a plurality of conductor bars each possessing a rectangular cross section and being formed in a loop, each conductor bar including a plurality of Roebel-transposed conductor elements, with at least one conductor element possessing a plurality of conductive strands stacked relative to each other and following a common path within the conductor bar; and
each conductor bar including an insulator for electrically insulating the conductor elements from each other.

18. The electric machine of claim 17, wherein each of the strands possesses a rectangular cross section and a height of 0.3-0.8 mm.

19. The electric machine of claim 17, wherein the at least one conductor element comprises:
a first strand and a second strand wrapped around each other so that the first and second strands are transposed.

20. The electric machine of claim 17, wherein the at least one conductor element comprises:
a first strand and a second strand, the first strand passing through a slit in the second strand and the second strand passing through a slit in the first strand so that the first and second strands are transposed.
